(19) United States
(12) Patent Application Publication
(10) Pub. No.: US 2020/0304049 A1
(43) Pub. Date: Sep. 24, 2020

(54) PULSE WIDTH MODULATION PATTERN GENERATOR AND CORRESPONDING SYSTEMS, METHODS AND COMPUTER PROGRAMS

(71) Applicant: Infineon Technologies AG, Neubiberg (DE)

(72) Inventor: Chao Li, Beijing (CN)

(21) Appl. No.: 16/673,528

(22) Filed: Nov. 4, 2019

(30) Foreign Application Priority Data
Oct. 26, 2018 (CN) PCT/CN2018/112206

(51) Int. Cl. H02P 21/00; H02M 7/5387; H02P 27/08

(52) U.S. Cl. CPC H02P 21/0089; H02P 27/08; H02M 7/5387

(57) ABSTRACT

A pulse width modulation pattern generator for controlling a three-phase power inverter is provided. In at least one mode of operation, the three-phase power inverter is controlled in such a way that at least four power devices of the power inverter take turns in bearing a full current during application of null vectors in a control period.

### CROSS-REFERENCE TO RELATED APPLICATION

This application claims priority to International Application No. PCT/CN2018/112206 filed on Oct. 26, 2018, which is incorporated by reference herein in its entirety.

### TECHNICAL FIELD

The present application relates to pulse width modulation (PWM) pattern generators and corresponding systems, methods and computer programs.

### BACKGROUND

Permanent magnet synchronous motors (PMSMs) are used in a variety of applications, including automotive, industrial and consumer applications. For hybrid electrical vehicles and electrical vehicles, like electrical cars, PMSMs are used, e.g., as motor generators both to drive the vehicle and to generate current for the vehicle for example during deceleration phases. When the motor generator is used as a motor, field-oriented control (FOC) via space vector pulse width modulation (SVPWM) is an often-used approach for driving the motor via a three-phase power inverter. Field oriented control is for example described in U.S. Pat. No. 9,614,473 B1. Also in other applications, an electric motor may be driven using FOC. A three-phase power inverter in many applications includes three half-bridges, each half-bridge comprising two switches like insulated gate bipolar transistors (IGBTs) or other transistors. Such switches are also referred to as power switches. Each half-bridge further comprises two diodes and each diode is coupled in anti-parallel to an associated switch. In anti-parallel means that a forward direction of the diode is opposite to a preferred current flow direction of the associated switch, for example opposite a forward direction of an IGBT used as a switch. These diodes in some switch implementations may be inherent in the design of the switch, whereas in other applications they may be provided separately. Such diodes are also referred to as freewheeling diodes in some contexts. The switches and diodes will be jointly referred to as power devices herein.

In operation, when the motor is turning the switches are controlled based on a feedback signal from the motor indicating the angular position using control vectors, or, in other words, a feedback angle. In such a control scheme, the power devices take turns in conducting current flowing through windings of the motor to provide torque for driving the motor.

However, this approach may cause problems when the rotor of the motor is locked, i.e., not moving. This may for example occur in certain drive situations in an electric vehicle. In this case, the current always flows through the same power devices determined by the position in which the rotor is locked, which may cause overheating of these power devices, also referred to as hotspots. Similar problems may occur in other cases, e.g., at very slow rotation speeds of the rotor.

To further illustrate this, there are three worst case scenarios for electrical vehicles for the operation of a three-phase inverter, which are referred to as the peak power case, the peak torque case and the locked rotor torque case. Peak power often occurs at an acceleration stage, i.e., when the vehicle is accelerated and requires maximum power for acceleration, such that the motor may draw maximum power. The peak torque case occurs for example when driving upward a hill. The locked rotor torque case may occur when starting to drive upwards a hill or climbing an obstacle, i.e., when the angular rotation of the motor of the electrical vehicle is substantially reduces or completely stopped.

Generally, the output torque of a motor is proportional to the phase current flowing through the motor. In many designs, the torque in the locked rotor torque case, i.e., the torque generated by the motor in case of a locked rotor, is designed to be close to the peak torque. Since in such designs the power loss at the locked rotor torque is higher than the power loss at peak torque and peak power cases, the locked rotor torque case in such designs may be seen as the worst case. This means that the power loss at the locked rotor torque case determines the design of the power switches when designing the three-phase power inverter, as the power switches have to be able to withstand the hotspot temperature and the power losses in the locked rotor case (e.g., heating due to the power losses). Designing power switches for higher power losses, while possible, generally increases area requirement and the cost of the power switches.

### SUMMARY

According to an embodiment, a system includes pulse width modulation pattern generator configured to be coupled to a three-phase power inverter, wherein the three-phase power inverter comprises three half-bridges, and each half-bridge of the three half-bridges comprises two switches and two diodes coupled in anti-parallel to the switches as power devices, wherein: the pulse width modulation pattern generator is configured to control the three-phase power inverter using field-oriented control via space vector pulse width modulation, in at least one mode of operation, in each control period of the space vector pulse width modulation, at least four of the power devices of the three-phase power inverter take turns in bearing a full current during application of a null vector, the null vector is a vector in which all three half-bridges are controlled to be in a same state, and the full current is an absolute current value of a maximum phase current among three phase currents of the three-phase power inverter.

According to another embodiment, a method for controlling a three-phase power inverter comprising three half-bridges that each comprise two switches and two diodes coupled in anti-parallel to the switches as power devices, the method comprising: controlling the three-phase power inverter using field-oriented control via space vector pulse width modulation; wherein in at least one mode of operation, in each control period of the space vector pulse width modulation, four of the power devices take turns in bearing a full current during application of a null vector, the null vector is a vector in which all three half-bridges are controlled to be in a same state, and the full current is an absolute current value of a maximum phase current among three phase currents of the three-phase power inverter.

The above summary is merely intended to give a brief overview over some features of some embodiments and is not to be construed as limiting, as other embodiments may comprise other features than the ones explicitly defined above.

### BRIEF DESCRIPTION OF THE DRAWINGS

FIG. 1 is a diagram illustrating a system to an embodiment;

FIG. 2 is a flowchart illustrating a method according to an embodiment;

FIG. 3 is a diagram illustrating field-oriented control using space vector pulse width modulation;

FIG. 4 is a further diagram illustrating field-oriented control using space vector pulse width modulation;

FIG. 5 is a diagram of a reference example illustrating conventional field-oriented control;

FIG. 6 is a diagram of a further reference example illustrating conventional field-oriented control at another rotor position;

FIG. 7 is a diagram illustrating which power devices carry full current in which sector of conventional field-oriented control;

FIG. 8 is a diagram illustrating field-oriented control using space vector pulse width modulation according to an embodiment;

FIG. 9 is a diagram illustrating field-oriented control using space vector pulse width modulation according to another embodiment;

FIG. 10 illustrates a dual three-phase motor system as an example application scenario; and

FIG. 11 illustrates a dual three-phase motor useable in the system of FIG. 10.

### DETAILED DESCRIPTION OF ILLUSTRATIVE EMBODIMENTS

In the following, various embodiments will be discussed in detail below referring to the attached drawings. These embodiments are given by way of example only and are not to be construed as limiting. Features from different embodiments may be combined to form further embodiments. Variations, modifications and details described with respect to one of the embodiments are also applicable to other embodiments and will therefore not be described repeatedly.

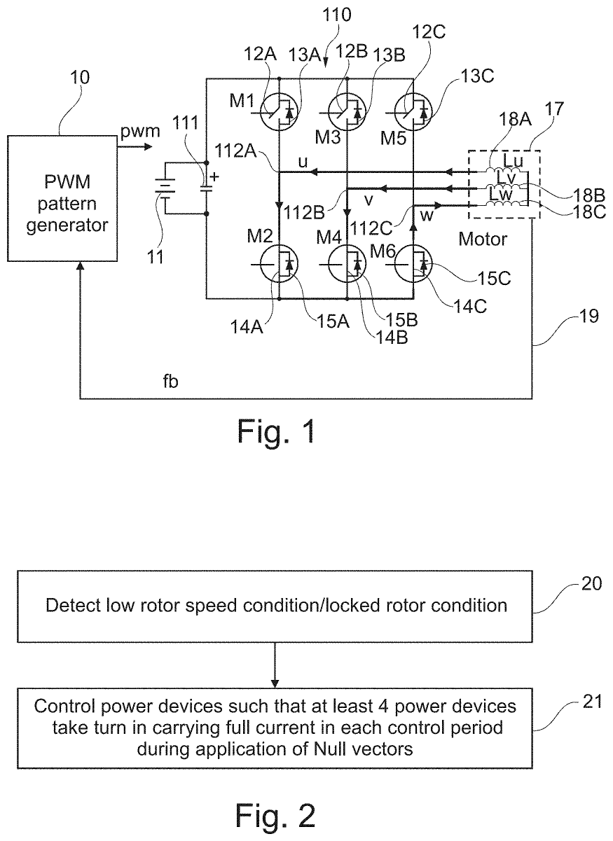

FIG. 1 is a diagram illustrating a system according to an embodiment, including a pulse width modulation (PWM) pattern generator 10 which at least in one mode of operation employs techniques according to embodiments as disclosed herein and as will be described further below.

The system of FIG. 1, besides PWM pattern generator 10, comprises a power source 11, in case of a vehicle for example the battery of the vehicle, a three-phase power inverter generally labeled 110 and a motor 17. A capacitor 111 may be coupled in parallel to power source 11.

The three-phase power inverter 110 includes three half-bridges. A first half-bridge comprises a first high-side device M1 and a first low-side device M2, a second half-bridge comprises a second high-side device M3 and a second low-side device M4, and a third half-bridge comprises a third high-side device M5 and a third low-side device M6. Each half-bridge is coupled between a first terminal of power source 11 and a second terminal of power source 11. Each of high-side devices M1, M3, M5, comprises a respective high-side switch 12A, 12B, 12C and a respective diode 13A, 13B, 13C coupled in anti-parallel to the respective high-side switch 12A, 12B, 12C. Likewise, each of low-side devices M2, M4 and M6 comprises a respective low-side switch 14A, 14B, 14C and a respective diode 15A, 15B, 15C coupled in anti-parallel to the respective low-side switch 14A, 14B, 14C. In some embodiments, switches 12A-12C and 14A-14C may be implemented as transistors, for example insulated gate bipolar transistors (IGBTs), bipolar junction transistors (BJTs) or field effect transistors like metal oxide semiconductor field effect transistors (MOSFETs). Diodes 13A-13C and 15A-15C may be separately provided diodes or, in some cases, may be diodes part of the transistor design of the respective switch, for example body diodes. Switches 12A-12C, 14A-14C and diodes 13A-13C, 15A-15C are collectively referred to as power devices herein. Therefore, power inverter 110 in the embodiment of FIG. 1 comprises 12 such power devices.

Power inverter 110 has three output nodes 112A, 112B, 112C, each located between a respective pair of high-side device and low-side device, as shown in FIG. 1. The half-bridges and their respective output nodes are also referred to as phases U, V and W, respectively, herein, and the current flowing via the respective output node is also referred to as phase current. Motor 17 comprises three windings 18A, 18B, 18C. Windings 18A-18C may be stator windings, while a rotor has permanent magnets, in some embodiments. In other embodiments, windings 18A-18C may be rotor windings. A first end of winding 18A is coupled to output node 112A, a first end of winding 18B is coupled to output node 112B, and a first end of third winding 18C is coupled to output node 122C, i.e., in operation, each of the three phase currents is provided to an associated winding 18A-18C. Second ends of windings 18A, 18B and 18C are coupled together. In operation, high-side switches 12A-12C and low-side switches 14A-14C are driven by pulse width modulated signals pwm output by PWM pattern generator 10, causing current flow to motor 17, which in turn causes windings 18A-18C to generate magnetic fields, which generate a motor torque. The pulse width modulated signals pwm are generated based on a field-oriented control scheme using space vectors, as will be explained later in greater detail, based on a feedback signal fb indicating an angular position of the rotor of motor 17 received via a feedback path 19, i.e., a feedback angle. Such an angular position may be measured by conventional sensors.

In at least one mode of operation, PWM pattern generator 10 is configured to generate signals pwm in a way that in each control period, at least four power devices take turns in bearing a full current during application of a null vector, where all three half-bridges are controlled in the same manner, as further explained later, during a control period. Such a mode of operation may be for example a mode for a low rotor speed, in particular a case where the rotor is locked, but also may be employed in other situations. A control period, as will be described later in greater detail, is a period during which a certain sequence of vectors is applied to determine the signals pwm. After the control period, as long as the angular position of the rotor is in a same sector, the sequence of vectors is repeated in a next control period. A full current is essentially a maximum current flowing through the power inverter at a given time. To be more precise, the full current is an absolute current value of the maximum phase current of the three phase currents (currents through nodes 112A-112C in FIG. 1) during charging motor windings or discharging of motor windings, i.e., throughout a complete control period, where the full current may be an average value in a control period or a transient value at any time of the control period. In many control schemes, at each given time, one of the power devices bears the sum of currents flowing through two other power devices. For example, in a situation as shown in FIG. 1 where switches 12A-12C are open (non-conducting between their respective load terminals) and switches 14A-14C are closed (conducting between their terminals, a current may flow via diode 15C to motor 17, which is a sum of currents flowing from motor 17 via switches 14A, 14B as shown). In other phases of a control period, similar situations may occur, where a current via one of the power devices (the full current) is a sum of currents flowing via two other power devices.

PWM pattern generator 10 may be implemented using software, hardware, firmware or combinations thereof. For example, PWM pattern generator 10 may be implemented using one or more processors programmed by a corresponding program code, but may also be implemented using hardware like application-specific integrated circuits (ASICs) or field programmable gate arrays (FPGAs).

FIG. 2 is a flowchart illustrating a method according to an embodiment. The method of FIG. 2 may be implemented in PWM pattern generator 10 of FIG. 1, but may also be implemented independently therefrom. In some embodiments, the method of FIG. 2 may be implemented using a program code, which may for example be provided on a tangible storage medium, and which, when running on a processor, causes the method of FIG. 2 to be carried out. Implementations fully or partially in hardware, for example using ASICs, FPGAs or other specific hardware, are also possible.

At 20 in FIG. 2, the method comprises detecting a low rotor speed condition or a locked rotor condition. For example, it may be detected when the rotor speed of a motor is below a predefined threshold, for example at or near zero indicating a locked rotor condition.

At 21, upon detecting the low rotor speed condition or the locked rotor condition at 20, power devices of a three-phase power inverter, for example the power devices of power inverter 110 of FIG. 1, are controlled such that at least four power devices take turns in carrying a full current in each control period while null vectors are applied, as explained briefly above for the system of FIG. 1. It should be noted that in other embodiments, detecting the low rotor speed condition at 20 may be omitted, and the control at 21 may be performed irrespective of the condition of the motor, in particular a rotor thereof.

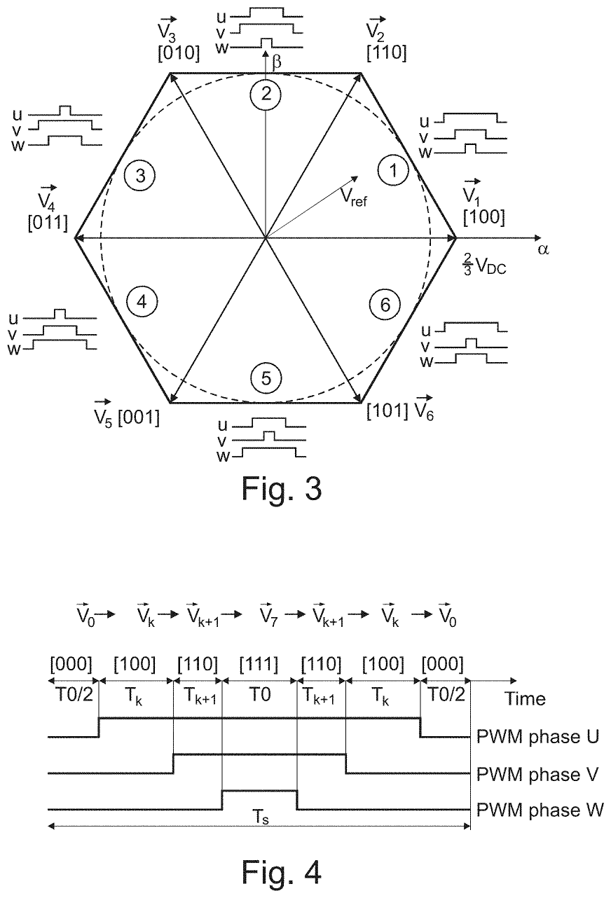

Next, control techniques for power devices of a three-phase power inverter according to some embodiments, which may be used to control the power devices such that at least four power devices take turns in carrying a full current in each control period while null vectors are applied, will be described in more detail. For better understanding, first referring to FIGS. 3-7, field-oriented control using space vector pulse width modulation will be described in general, and the problem of hotspots in case of a locked motor condition will be explained in some detail. Following this, various non-limiting embodiments will be described.

FIG. 3 shows six basic active vectors \vec{V}₁ to \vec{V}₆ and six sectors 1-6 for an electric period. An electric period corresponds to a full rotation of the rotor by 360°. Each of the active vectors \vec{V}₁ to \vec{V}₆ are associated with a respective angle. For example, the angle of \vec{V}₁ is 0°, the angle of \vec{V}₂ is 60°, the angle of \vec{V}₃ is 120°, the angle of \vec{V}₄ is 180°, the angle \vec{V}₅ is 240° and the angle of \vec{V}₆ is 300°. In addition, two so-called null vectors \vec{V}₀=[000] and \vec{V}₇=[111] are used. The three digits of the vector indicate the control of the high-side switches of a three-phase power inverter (for example high-side switches 12A, 12B, 12C in FIG. 1), a “1” indicating a closed switch and a “0” indicating an open switch. The corresponding low-side switch is controlled in an inverse manner to the respective high-side switch, i.e., when the high-side switch of a half-bridge is closed, the low-side switch is open and vice versa. With null vectors, therefore all three half-bridges are controlled in the same manner.

The control within a control period depends on the sensed angle of the rotor, also referred to as electrical degree. When for example the sensed angle is 240°, this corresponds to vector \vec{V}₅=[000]. This means that for the first half-bridge (phase U), the high-side power switch (12A) is open and the low-side switch (14A) is closed, for the second half-bridge (phase V) also the high-side power switch (12B in FIG. 1) is open and the low-side power switch (14B in FIG. 1) is closed, and for the third half-bridge (phase W) the high-side power switch (12C in FIG. 1) is closed and the low-side power switch (14C in FIG. 1) is open.

When an instant angle does not correspond to any of the basic active vectors, for example corresponds to vector \vec{V}_{ref} of FIG. 3, the vectors delimiting the sector in which the instant angle is used for control. For example, \vec{V}_{ref} is in sector 1, so the vectors \vec{V}₁ to \vec{V}₂ are used for control according to a pulse width modulated scheme, together with the null vectors \vec{V}₀ and \vec{V}₇. For example, in a given sector k (k=1, 3, 5; i.e., odd sector number), the control scheme may be according to \vec{V}₀->\vec{V}ₖ->\vec{V}ₖ₊₁->\vec{V}₇->\vec{V}ₖ₊₁->\vec{V}ₖ->\vec{V}₀. An example for the vector \vec{V}_{ref} in sector 1 is shown in FIG. 4. Here, the control transitions from \vec{V}₀=[000] to \vec{V}₁=[100] to \vec{V}₂=[110] etc. Signals “pwm phase U”, “pwm phase V” and “pwm phase W” show the control signals for the three phases U, V, W of the three-phase power inverter for example as shown in FIG. 1, where a high signal indicates a closed high-side switch and open low-side switch, while a low signal indicates an open high-side switch and closed low-side switch, and also corresponds to a voltage at the respective output node (high or low), e.g., output nodes 112A-112C of FIG. 1. For sectors k=2, 4, 6; i.e., even sector number, in the above sequence \vec{V}ₖ and \vec{V}ₖ₊₁ are exchanged.

To give more details, FIG. 4 shows control over a control period Ts. As used herein, Ts will be used both to refer to the control period and to the time duration thereof. Times T0, Tk and Tk+1 indicate the durations during which the respective vectors are applied, as shown in FIG. 1. For example, in FIG. 4 first the null vector \vec{V}₀ is applied for T0/2, then \vec{V}₁ is applied for a time duration Tk, then \vec{V}₂ is applied for a time duration Tk+1 etc. Tk and Tk+1 are calculated according to the angle between vector \vec{V}_{ref}, i.e., the current vector, and \vec{V}₁ (\vec{V}ₖ) in general) and a target voltage amplitude of the vector \vec{V}_{ref}. For example, the closer to \vec{V}₁ \vec{V}_{ref} is, the longer Tk is compared to Tk+1. To is then equal to Ts/2−Tk−Tk+1.

When the angle of the vector \vec{V}_{ref} corresponds to one of the six vectors \vec{V}₁ to \vec{V}₆, a similar control scheme as shown in FIG. 4 is used, but the times Tk and Tk+1 are merged to a single time Tkk where the corresponding basic vector is applied.

The corresponding control frequency Fs=1/Ts may be for example 8 kHz for middle and high motor speeds, may be changed to 4 kHz for low motor speeds, and changed to 2 kHz for very low motor speeds including a locked rotor case with high torque output. In other words, Ts may be changed depending on predefined thresholds. It should be noted that the control scheme illustrated in FIG. 4 may also be used in some embodiments in some other modes of operation, for example at higher rotor speeds, when no locked rotor or very low rotor speed is detected.

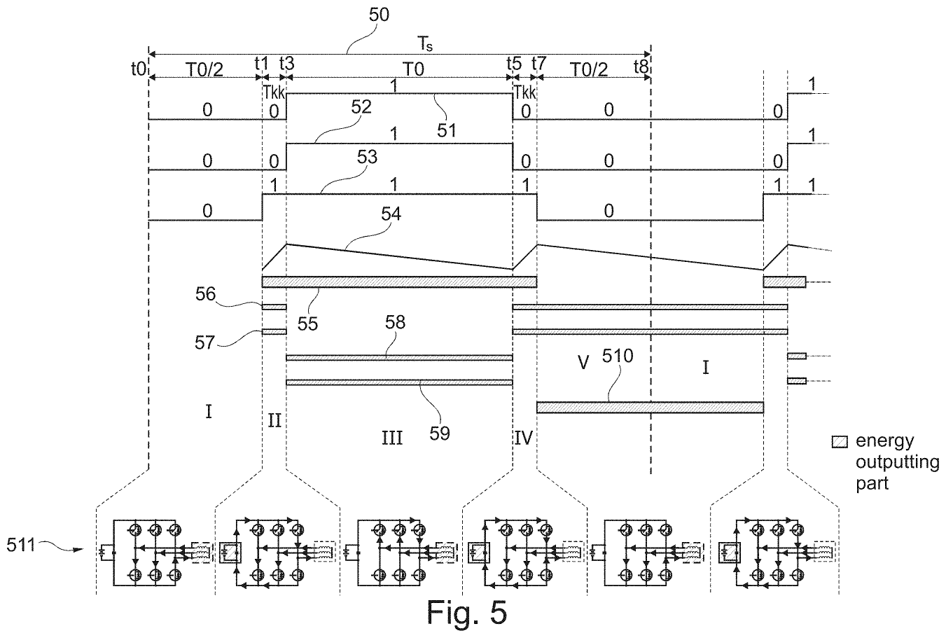

Next, a case where the rotor is locked will be explained in more detail. FIG. 5 shows a reference example where the motor is locked at an angle of 240° corresponding to active vector \vec{V}₅=[001]. For ease of explanation, FIG. 5 will be described referring to FIG. 1. A double arrow 50 denotes the control period Ts, which is divided in time slots I-V. A curve 51 shows the control signal for phase U, a curve 52 shows the control signal for phase V and a curve 53 shows a control signal for phase W. During times Tkk, the vector \vec{V}₅ is applied. A curve 54 shows the current of phase W, including the changing current (rising part of curve 54) caused by applying the control vector \vec{V}₅ during the time period Tkk, where high-side switch 12C is closed to generate current flow. Numeral 55 denotes the average current through the high-side switch of phase W (switch 12C of FIG. 1), numeral 56 denotes the average current through low-side switch 14A, numeral 57 denotes the current flow through low-side switch 14B, numeral 58 denotes the current through diode 13A, numeral 59 denotes the current through diode 13B, and numeral 510 denotes the current through diode 15C of FIG. 1. Thicker bars illustrate the aforementioned full current, while thinner bars illustrate a partial current. At 511 in FIG. 5, current flow through the device system of FIG. 1 is shown for each of phases I to V. For example, during phase II the full current flows through high-side switch 12C which is closed, being a sum of currents through low-side switch 14A and low-side switch 14B. Likewise, for example during phase V, full current flows through diode 15C, which is a sum of currents through low-side switches 14A, 14B, as can be seen by the diagrams at 511. As mentioned, the waveforms 51, 52 and 53 are also indicative of the output voltage of the nodes 112A, 112B and 112C, which are at a positive potential (high signal in FIG. 5) when the respective high-side switch is closed, and at low potential when the respective low-side switch is closed, corresponding to the function of the half-bridges. It should also be noted that the waveforms are shown in an ideal manner, whereas in actual implementations, for example edges may have other forms than the vertical edges shown in the Figures.

In FIG. 5, Tk and Tk+1 are combined as one timeslot Tkk as explained above because the waveform of the pulse width modulation signal of phase U is completely the same as the waveform of the signal of phase V at the angle of 240°. In other words, rising and falling edges of the pulse width modulation signal of phase U (51 in FIG. 5) are at the same points in time as rising and falling edges of phase V (signal 52 of FIG. 5). This phenomenon that two of the three pulse width modulated signals of phases U, V and W are the same applies to all cases where an instant angle position of the motor coincides with one of the vectors \vec{V}₁ to \vec{V}₆, i.e., with one of the basic active vectors.

Generally, when the rotor is locked, (locked rotor torque case) high current flows through the motor winding for providing a locked rotor torque, and charging time of the motor windings through time period Tkk is very short, as there is no electromagnetic force voltage on the winding due to no spinning of the rotor. For example, the two periods with lengths Tkk may have a duration of about 10% of the control period Ts as shown in FIG. 5 or less. The exact length of Tkk changes according to different input parameters like battery voltage, resistance and inductance of the stator of the motor, required current to provide the locked rotor torque.

The following more detailed analysis of the situation of FIG. 5 starts at time t1 with time slot II. Here, vector \vec{V}₅ is applied. As mentioned, and as indicated at 55, the motor winding connected to phase W receives all current from the inverter. At t1, the current source (for example current source 11 of FIG. 1) outputs energy to charge the motor windings via the closed high-side switch 12C, flowing back via the closed low-side switches 14A and 14B. Therefore, high-side switch 12C carries the full current, while low-side switches 14A, 14B each carry about half the full current.

Between t3 and t5 in time slot III, the null vector \vec{V}₇=[111] is applied for a duration of T0. Here, low-side switches 14A, 14B are opened, and high-side switches 12A, 12B are closed. High-side switch 12C remains closed, and low-side switch 14C remains open. A freewheeling current due to stored energy in the motor winding flows as illustrated at 511 for time slot III, where high-side switch 12C carries the full current, and diodes 13A, 13B carry about half the current.

Between t5 and t7 during time slot IV, the motor windings are charged again from the current source, as was explained for time slot II above.

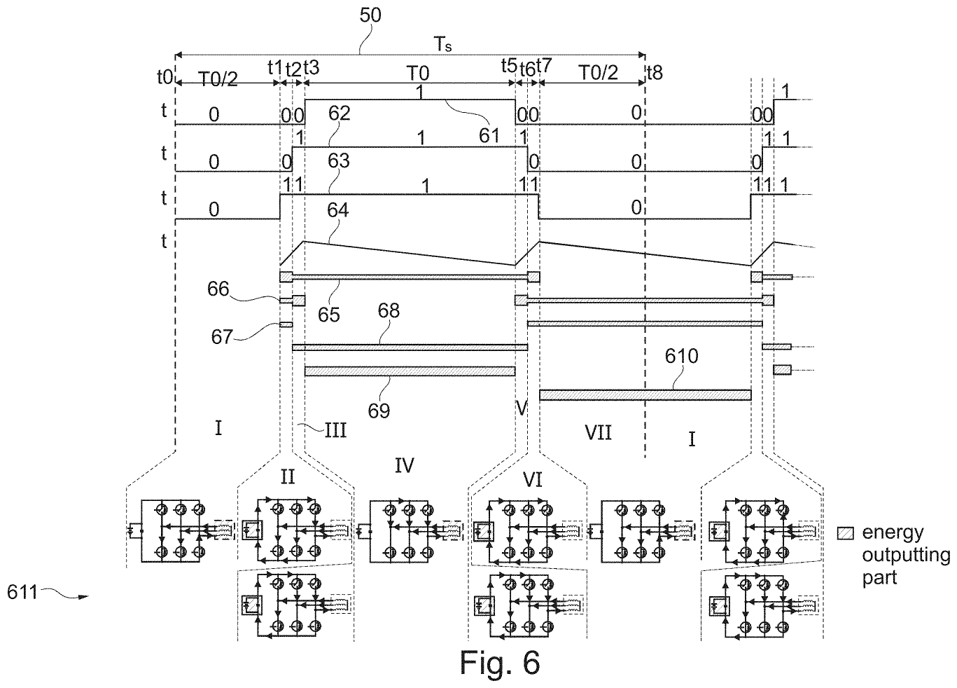

When in time slot V the null vector \vec{V}₀=[000] is applied for T0/2 and then again for T0/2 in a next time slot I of a next control period, i.e., applied altogether for a duration T0. All low-side switches 14A, 14B, 14C are closed, and high-side switches 12A, 12B, 12C are opened. A freewheeling current due to stored energy in the motor windings flows via low-side switches 14A, 14B and diode 14C as shown at 511 for time slots V, I and as also shown in FIG. 1. In this case, diode 15C carries the full current, and low-side switches 14A, 14B each carry about half the current. It should be noted that in implementations where an IGBT is used as switch, the switch 14C is reversed biased, so essentially all the current flows via the diode. In other switch implementations like MOSFETs, in principle current could also flow via the closed switch 14C, but diode 15C in usual implementations carries at least most of the current due to lower resistance. In the next control period the same action repeats. As the motor is in a rotor-locked condition or in a condition with very slow rotational speed, also the motor angle does not progress or does not progress fast to a next sector of the field-oriented control scheme (see FIG. 6), such that the control period illustrated with respect to FIG. 5 may be repeated many times.

As can be seen in FIG. 5, not all twelve power devices are active (carry current) at the locked-rotor torque case, but only six power devices are involved. Moreover, among the six power devices involved, the average current when conducting is not the same. In the example of FIG. 5, switch 12C and diode 15C carry the full current, whereas other power devices involved carry only about half this full current. Moreover, for the power devices involved, the time during which they are conducting current is not the same. For example, high-side switch 12C as seen in FIG. 5 carries current for T0+2*Tkk, whereas diode 15C carries the full current for a duration of T0. This means that the duty cycle for switch 12C may be about 55%, assuming that 2*Tkk is about 10% of Ts, and the duty cycle of diode 15C is about 45%.

If assuming that the voltage across switch 12C is about the same as the voltage drop across diode 15C when carrying the full current, conduction power loss of diode 15C due to the different duty cycles is about 82% (45/55) of the power loss in high-side switch 12C. Therefore, high-side switch 12C may become hottest (hottest hotspot), and diode 15C is the second hottest hotspot. Other power devices involved, as they carry only about half the full current, are less critical.

In some conventional implementations to reduce problems with hotspots, balancing power loss between the two hottest devices (in the example of FIG. 5 high-side switch 12C and diode 15C) is performed. For example, in FIG. 5 to achieve this, the duration T0 of time slot III where the vector \vec{V}₇ is applied is reduced, and the duration of the two time slots I, V T0/2 where the vector \vec{V}₀ is applied is increased accordingly. However, as the differences in duty cycles for these devices are not very high, the effect is limited. In particular, in the numerical example given above, in this case the duty cycle for high-side switch 12C would be reduced from 55% to 50%, which is a comparatively low reduction of power loss. Furthermore, this approach is only feasible if the instant angular position of the rotor corresponds to one of basic active vectors \vec{V}₁ to \vec{V}₆.

Before turning to the techniques for reducing hotspots according to various embodiments, with reference to FIG. 6 the more general case where the instant angle of the rotor is in any of sectors 1-6 of FIG. 3 without coinciding with one of the vectors \vec{V}₁ to \vec{V}₆ will be discussed referring to FIG. 6.

FIG. 6 shows an example where the angle is in sector 4 of FIG. 3, with vector \vec{V}ₖ=\vec{V}₄=[011] and vector \vec{V}ₖ₊₁=\vec{V}₅=[001]. In FIG. 6, numeral 50 again denotes the control period, a curve 61 shows the control for phase U (similar to curve 51 of FIG. 5), a curve 62 shows the control for phase V (similar to curve 52 of FIG. 5), and a curve 63 shows the control for phase W (similar to curve 53 of FIG. 5). A curve 64 shows the current of phase W and/or U, corresponding to a current flowing through 112C and/or 112B of FIG. 1. A main difference to FIG. 5 is that each of the time slots with duration Tkk where vector \vec{V}₅ is applied, is replaced by two time slots with durations Tk+1 and Tk, where the vectors \vec{V}₅ and \vec{V}₄ are applied (time slots II, III and V, VI of FIG. 6). Numeral 62 denotes the average current through high-side switch 12C (similar to 55 of FIG. 5), numeral 66 denotes the average current through low-side switch 14A (similar to 56 of FIG. 5), numeral 67 denotes the average current through low-side switch 14B (similar to 57 of FIG. 5), numeral 68 denotes the average current through diode 13A (similar to 58 of FIG. 5), and numeral 610 denotes the average current through diode 15C is shown (similar to 510 of FIG. 5). The vector \vec{V}₅ is applied in time slots II, VI, and the vector \vec{V}₄ is applied in time slots III, V.

Similar to FIG. 5, also in the situation of FIG. 6 the charging time (time slots II, III, V, VI) are a comparatively small part of a control period, in the example shown in FIG. 6 about 10% of Ts, as in FIG. 5. Furthermore, for the example of FIG. 6 it is assumed that Tk=Tk+1. This is for example exactly the case if the vector \vec{V}_{ref} is exactly between \vec{V}₄ and \vec{V}₅. For other positions, the relationship may vary. Furthermore, the proportion of the total charging time (2Tk+2Tk+1) in a control period Ts depends on input parameters like supply voltage, resistance and inductance of the stator of the motor (for example windings 18A-18C of FIG. 1) or current needed through provide the locked rotor torque.

Explanation of the control scheme of FIG. 6 starts in time slot II, where the vector \vec{V}₅ is applied for a time Tk+1. Again, for convenience reference will be made to the system of FIG. 1 for ease of explanation. In phase II, current source 11 outputs energy to charge the motor windings via closed high-side switch 12C and low-side switches 14A, 14B, where high-side switch 12C carries the full current (65 in FIG. 6), whereas low-side switches 14A, 14B each carry about the half current.

During time slot III, current source 11 continues to output energy to charge the motor windings, in this case via high-side switches, 12B, 12C which are closed and low-side switch 14A which is closed. In this case (66 in FIG. 6), low-side switch 14A carries the full current, and high-side switches 12B, 12C (65, 67 in FIG. 6) each carry about half the full current.

During time slot IV, the null vector \vec{V}₇=[111] is applied. High-side switches 12A-12C are closed and low-side switches 14A-14C are open. In this case, a freewheeling current due to stored energy in the motor windings flows as shown for time slot IV at 611 of FIG. 4. Diode 13A carries the full current (69 in FIG. 6), whereas high-side switches 12B, 12C each carry about half the full current (65, 68 in FIG. 6).

In time slot V, the situation is essentially the same as in time slot III, where also the vector \vec{V}₄ is applied. As in time slot III, low-side switch 14A carries the full current, whereas high-side switches 12B, 12C each carry about half the current.

In time slot VI, the charging continues, where the situation essentially corresponds to the situation in time slot II, where also the vector \vec{V}₅=[001] is applied. As in time slot II, high-side switch 12C carries the full current and low-side switches 14A, 14B each carry about half the full current.

In time slot VII and a next time slot I, the null vector \vec{V}₀=[000] is applied for a time T0 (T0/2 in time slot VII and T0/2 in time slot I). The freewheeling current from the motor windings flows via low-side switches 14A, 14B and diode 15C as shown at 611 for time slots VII, I. Diode 15C carries the full current, and low-side switches 14A, 14B each carry about half the full current.

In the next control period Ts, the same action repeats as long as the rotor is locked. The following features and properties may be deduced from the example of FIG. 6.

First of all, similar to FIG. 5, not all twelve power devices of the power inverter carry current during a locked rotor case, but there are only six power devices involved. Moreover, among these six power devices, the average current of each one conducting is not the same. In the example of FIG. 6, only high-side switch 12C, low-side switch 14A, diode 13A and diode 15C carry the full current, whereas other power devices only carry about half the full current.

However, among these four power devices carrying the full current, the times during which they carry the full current differs significantly. The time during which high-side switch 12C and low-side switch 14A carry the full current during a control period Ts is very short (2Tk+1 and 2Tk, respectively), which corresponds to a duty cycle of about 5%. The time during which diode 13A and diode 15C carry the full current is significantly longer, each for a period T0 corresponding to a duty cycle of 45%.

If similar as in the example of FIG. 5 it is assumed that the voltage drop is about the same for all twelve power devices, the conduction power loss of each power device is proportional to the duty cycle and the current carried during the current cycle. Therefore, in the example of FIG. 6 diodes 13A and 15C have by far the highest conduction power losses, whereas the power losses for the other four power devices involved is much lower. Therefore, these power devices create the most heat and form hotspots. Moreover, as their duty cycle is at least approximately the same, a balancing between the duty cycles between these two power devices, as explained as a conventional method for the situation in FIG. 5, is hardly possible.

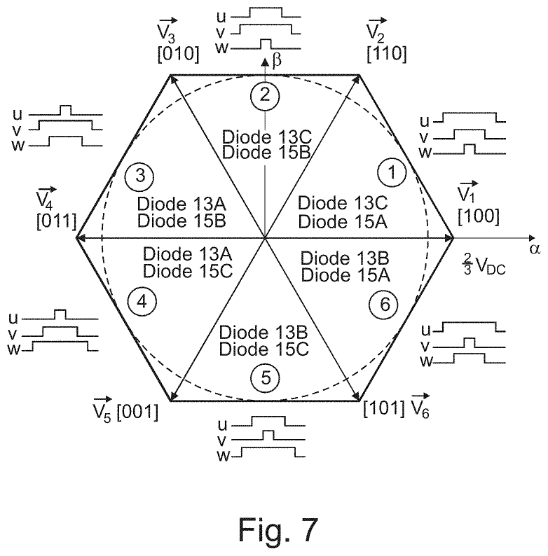

For the other five sectors (FIG. 6 shows an example for sector 4 as mentioned), a similar analysis can be performed, and in each case two of the diodes have the highest power losses. An overview is given in FIG. 7 which essentially reproduces FIG. 3 and additionally states which diodes have the highest power losses for each sector, each conducting the full current via a period T0.

For the above explanations, it can also be deduced that the reason why the conduction power loss at a locked rotor torque case is higher than in case of a low rotor speed with the same torque. To explain this, diode 15C is used as an example. Diode 15C is one of the hotspot devices in sectors 4 and 5, but not in any of the other sectors. If the motor is rotating (even when it is slow), the target vector position (\vec{V}_{ref} of FIG. 3) also moves in the vector map through sectors 1-6. Therefore, in this case diode 15C is a hotspot device only in two of the six sectors, which gives an overall duty cycle of about 0.15 in an electric period (⅓*0.45)TE, i.e., one revolution of the motor, which is much lower than the duty cycle of 45% at the locked rotor torque case. Nevertheless, techniques discussed below may, e.g., also be applied to a case where the rotor is spinning with low speeds or in other situations.

In embodiments, to reduce power losses in at least one mode of operation, e.g., in a locked rotor case as already briefly mentioned with respect to FIGS. 1 and 2, in embodiments a three-phase power inverter is controlled by a PWM pattern generator like PWM pattern generator 10 of FIG. 1 such that at least four power devices of the three-phase power inverter take turn in conducting the full current while a null vector (\vec{V}₀=[000] or \vec{V}₇=[111] in the examples above) is applied. In other words, at least four power devices of the three-phase power inverter take turn in conducting a full current during a comparatively large part of the control period, for example during at least 60% of the control period or more, like during at least 80 &% or at least 90% of the control period Ts. In this way, conduction power losses in individual power devices may be reduced in some embodiments.

Control schemes according to embodiments discussed in the following are based on the two null vectors \vec{V}₀ and \vec{V}₇ and on the two basic active vectors delimiting a sector in which the angle corresponding to an instant rotor position is located (for example \vec{V}₁ and \vec{V}₂ when the vector \vec{V}_{ref} is in sector 1, etc.). Various approaches to implement such a control scheme will be discussed below:

Approach 1: For a first approach of a control scheme according to some embodiments, four different combinations of two vectors are defined, wherein in each combination one of the basic active vectors delimiting a respective sector is followed by one of the null vectors. As before, the two basic active vectors delimiting a sector will be named \vec{V}ₖ and \vec{V}ₖ₊₁, and the null vectors are \vec{V}₀ and \vec{V}₇. The four vector combinations are then \vec{V}ₖ->\vec{V}₀ (i.e., transition from \vec{V}ₖ to \vec{V}₀), \vec{V}ₖ->\vec{V}₇, \vec{V}ₖ₊₁->\vec{V}₀ and \vec{V}ₖ₊₁->\vec{V}₇. No vector is inserted between the vectors of the combination. In the first approach, in each control period Ts all four of these four combinations of two vectors are applied at least once.

In particular, in some embodiments the four combinations may be applied in sequences, without additional control vectors, wherein the order in which the four vector combinations are applied may be varied.

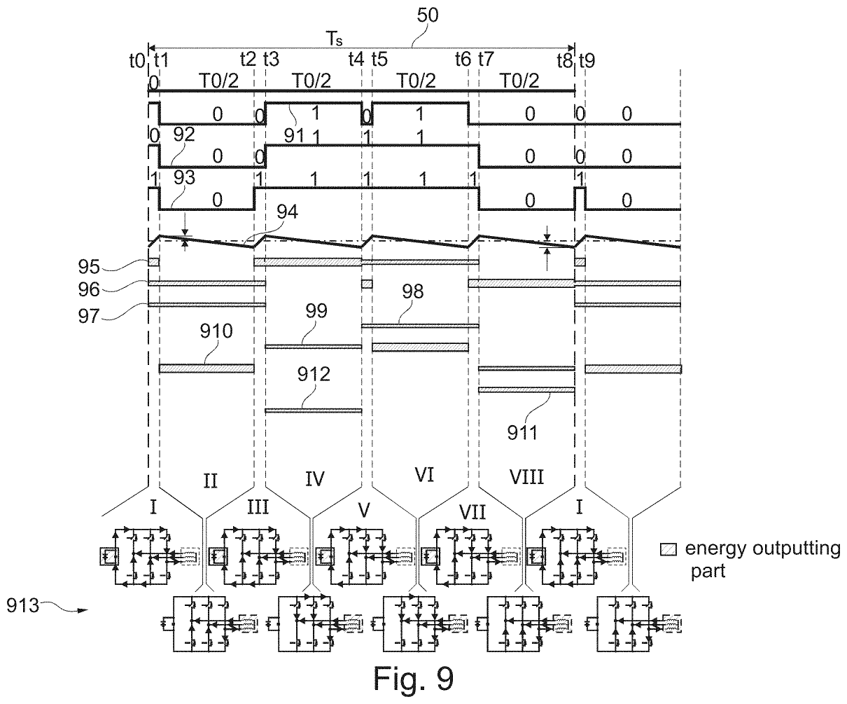

An example for this approach 1 will be discussed later referring to FIG. 9.

Approach 2: Also in approach 2, the two basic active vectors \vec{V}ₖ and \vec{V}ₖ₊₁ are used together with the two null vectors \vec{V}₀ and \vec{V}₇. For a control sequence, two combinations of three vectors are defined, wherein one of the combination comprises one of active vectors, for example \vec{V}ₖ, followed by the two null vectors (\vec{V}₀ and \vec{V}₇, in any order), and the other combination of three vectors comprises the respective other basic active vector, for example \vec{V}ₖ₊₁, followed by the two different null vectors in any order. For example, the combinations may be \vec{V}ₖ->\vec{V}₀->\vec{V}₇ and \vec{V}ₖ₊₁->\vec{V}₀->\vec{V}₇. Instead of the order \vec{V}₀->\vec{V}₇, or also the order \vec{V}₇->\vec{V}₀ may be used in one or both of the sequences. Both three vector combinations are then applied in a control sequence. In some embodiments, no further vectors are used. In other embodiments, additional vectors may be inserted between the two sequences, but not within the sequences.

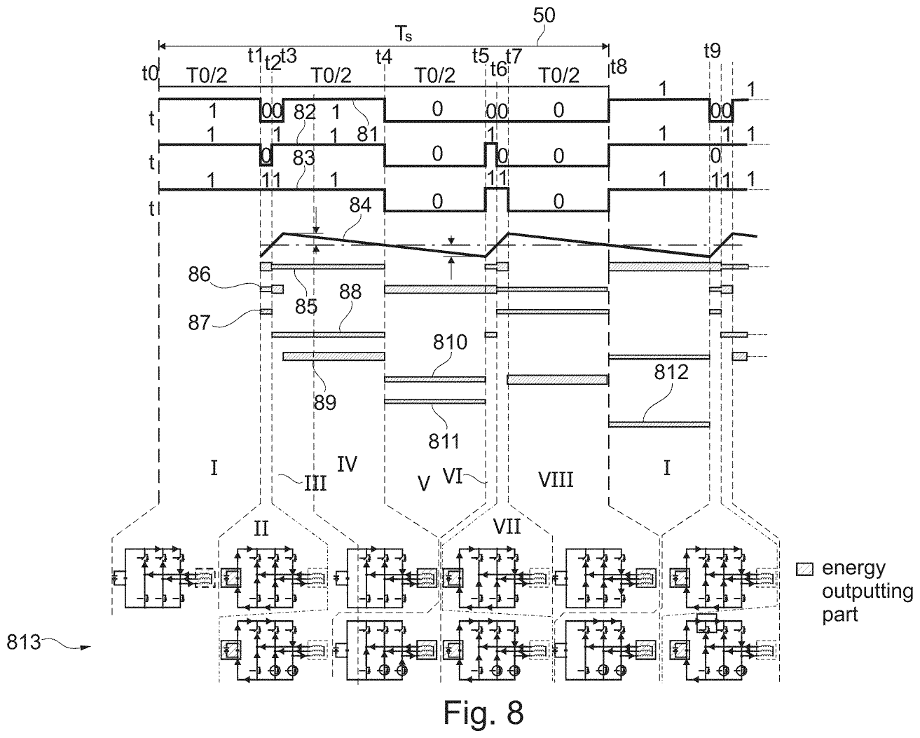

It should be noted that this approach 2 is related to approach 1 in so far as each vector combination in some sense “combines” two of the combinations of two vectors of approach 1. For example, \vec{V}ₖ->\vec{V}₀->\vec{V}₇ may be seen as a combination of \vec{V}ₖ->\vec{V}₀ and \vec{V}ₖ->\vec{V}₇. A specific example for this approach 2 will be later explained referring to FIG. 8.

Approach 3: Approach 3 is a mix of the approaches 1 and 2. Here, one of the combinations of three vectors of approach 2 is used, together with two of the combinations of two vectors of approach 1, in each control period. In some embodiments, the two combinations of two vectors used are those of the active vector not used in the combination of three vectors. For example, as combination of three vectors \vec{V}ₖ->\vec{V}₇->\vec{V}₀ may be used, and in addition the two combinations of two vectors \vec{V}ₖ₊₁->\vec{V}₀ and \vec{V}ₖ₊₁->\vec{V}₇ may be used.

After these explanations of the different approaches, specific examples for these approaches will be discussed referring to FIGS. 8 and 9. The way of representations in the diagrams of FIGS. 8 and 9, for ease of comparison and for better understanding, corresponds to the way the reference examples were discussed in FIGS. 5 and 6.

FIG. 8 illustrates a control scheme based on approach 2 above, using two combinations of three vectors, in this case with additional vectors inserted between the combinations. Numeral 50 again denotes the control period Ts. Each control period in this case may be divided into eight time slots labeled I-VIII, in which different control vectors are applied successively. Curves 81, 82 and 83 show the control of phases U, V, W similar to curves 51-53 of FIG. 5 and curves 61-63 of FIG. 6 and may therefore also illustrate a voltage at nodes 112A, 112B and 112C of FIG. 1, respectively. Furthermore, similar to curves 54 and 64, curve 84 shows a current for phase W and/or U, e.g., a current flowing via output node 112C of FIG. 1.

FIGS. 8 and 9 each illustrate a case where an angular position of the rotor is in sector 4, i.e., \vec{V}_{ref} is in sector 4, such that \vec{V}₄ and \vec{V}₅ are the basic active vectors delimiting the sector. Numeral 85 denotes the average current through high-side switch 12C, numeral 86 denotes the average current through low-side switch 14A, numeral 87 denotes the average current through low-side switch 14B, numeral 88 denotes the average current through high-side switch 12B, numeral 89 denotes the average current through diode 13A, numeral 810 denotes the average current through diode 15C, numeral 811 denotes the average current through diode 15B and numeral 812 denotes the average current through diode 13B. As before, thicker bars indicate full current, whereas thinner bars indicate about half the full current flowing.

At 813, essentially the power converter and motor of FIG. 1 are reproduced, showing the current flow in each phase.

In FIG. 8, similar to FIGS. 5 and 6, it is assumed that the total charging time where energy flows from battery current source 11 to the motor is about 10% of the control period Ts, corresponding to time slots II, III, VI and VII in FIG. 8. Furthermore, as for FIG. 6, for the subsequent analysis it is assumed that Tk+1 and Tk are equal. The real value, as explained for FIG. 6, may be depending on parameters like instant angle, battery voltage, resistance and inductance of motor stator and current needed to provide the locked rotor torque.

The following analysis starts in time slot 2. Here, the vector \vec{V}₅=[001] is applied. Current source 11 outputs power to charge windings 18A, 18C of motor 17 via high-side switch 12C, low-side switch 14A and low-side switch 14B, where high-side switch 12C carries the full current and low-side switches 14A, 14B each carry about half the current.

In time slot III, vector \vec{V}₄=[011] is applied, continuing the charging. Here, current source 11 continues to output energy to charge the motor windings via high-side switches 12B, 12C and low-side switch 14A. Low-side switch 14A carries the full current, and high-side switches 12B, 12C carry about half the full current.

In time slot IV, the null vector \vec{V}₇=[111] is applied for T0/2. Compared to time slot III, low-side switch 14A is opened and high-side switch 12A is closed, so that all high-side switches are closed. A freewheeling current flows as shown at 813 for phase IV via diode 13A and high-side switches 12B, 12C. Diode 13A carries the full current, whereas high-side switches 12B, 12C each carry about half the current.

During time slot V, the null vector \vec{V}₀=[000] is applied, opening all high-side switches 12A to 12C and closing all low-side switches 14A-14C. Freewheeling current flows as shown at 813 for phase V. Low-side switch 14A carries the full current, while diodes 15B and 15C each carry about half the full current.

After this, in time slots VI and VII, the motor is charged again by application of vector \vec{V}₄ followed by vector \vec{V}₅. In time slot VI, similar to time slot III, low-side switch 14A carries the full current, while high-side switches 12B, 12C each carry about half the full current. During time slot VII, similar to time slot II, high-side switch 12C carries the full current, while low-side switches 14A, 14B each carry about half the current.

In time slot VIII, again the null vector \vec{V}₀=[000] is applied. In this case, the freewheeling current flows via low-side switches 14A and 14B as well as diode 15C. Diode 15C carries the full current, while low-side switches 14A, 14B each carry about half the full current. Following this, in time slot I of a next control period Ts, the null vector \vec{V}₇=[111] is applied, closing all high-side switches and opening all low-side switches. Here, high-side switch 12C carries about the full current, while diodes 13A, 13B each carry about half the full current.

Then, the above described sequence is repeated. As already mentioned, FIG. 8 shows an example for approach 2 mentioned above. The first combination of three vectors is applied in time slots III, IV and V as \vec{V}₄->\vec{V}₇->\vec{V}₀, and the other combination of three vectors is applied in time slots VII, VIII and the next time slot I, as \vec{V}₅->\vec{V}₀->\vec{V}₇. Therebetween, in time slots II and VI, the respective other active vector delimiting the instant sector is applied.

In the example below, still not all twelve power devices carry current in the locked rotor torque case, but there are eight power devices involved. Of these eight power devices, there are four power devices carrying the full current, namely high-side switch 12C, low-side switch 14A, diode 15A and diode 15C. Each of these power devices, in contrast for example to FIG. 6, carry the full current while a null vector is applied, leading to a more even distribution of duty cycles among these four power devices. Using the numerical examples given above, the duty cycle of high-side switch 12C and low-side switch 14A for carrying the full current are each 27.5%, and the duty cycles carrying the full current for diodes 13A and 15C are each 22.5% of the control period. Therefore, these four power devices take turns in bearing the full current, and the maximum duty cycle a device bears the full current is reduced compared for example to FIG. 6. It should be taken into account that each of the four power devices also bears about half the full current for some time, which also contributes to some power losses.

To analyze more precisely and taking into account that these devices also bear half the full current during some time slots, when U is the voltage drop across each power device, I is the average value of the full current and it is assumed that the voltage drop across all 12 power devices is the same, the power losses P for the aforementioned devices may be calculated as follows:

P(high-side switch 12C)=(U*I*22.5%*Ts+U*I*2.5%*Ts+U*I*2.5%*Ts+U*0.5*I*22.5%*Ts+U*0.5*I*2.5%*Ts+U*0.5*I*2.5%*Ts)/Ts=41.25%*U*I.

The power loss for low-side switch 14A, P (low-side switch 14A) is the same as P (high-side switch 12C) and therefore also 41.25%*U*I.

The power loss for diode 13A and for diode 15C each is:

P(diode 13A)=P(diode 15C)=(U*I*22.5%*Ts+U*0.5*I*22.5%*Ts)/Ts=33.75%*U*I.

The above calculations are for a charging time proportion of 10%, i.e., (2*Tk+2*Tkk)=0.1*Ts.

The value for the power losses changes with parameters. As an example, below the power losses are calculated for a total charging time making up 5% of the control period Ts (2*Tk+2*Tkk=0.05*Ts), and 5% ripple of the full current. This is a realistic scenario for many applications, as for many applications in the locked rotor torque case the charging time is less than 10% and may be about 5% of the control period. For example, the inductance of each of the three motor windings 18A to 18C may be about 500 μH. The control frequency 1/Ts in such a case may be 2 kHz. This means the control period Ts is about 500 μs. In such a situation, the charging time from 95% to 105% of the average full current may be about 15 μs, which is 3% of Ts. In addition, an average value for carrying the full current via the switches is 2.5% less than the average value of the full current in Ts. The average value for carrying the full current via one of the diodes is 2.5% higher than the average value of the full current in Ts. For example, during time slot IV, the full current via diode 13A may be 2.5% higher than the average full current during Ts, and during time slot V the average value for the full current via low-side switch 14A may be 2.5% lower than the average full current over the complete control period Ts. This gives an overall variation of the full current of 5%, being the above-mentioned ripples. This leads to the following results for the power losses:

P(high-side switch 12C)=P(low-side switch 14A)=(U*0.975*I*23.75%*Ts+U*0.975*I*1.25%*Ts+U*0.975*I*1.25%*Ts+U*0.5*I*23.75%*Ts+U*0.5*I*1.25%*Ts+U*0.5*I*1.25%*Ts)/Ts=38.72%*U*I

P(diode 13A)=P(diode 15C)=(U*1.025*I*23.75%*Ts+U*0.5*I*23.75%*Ts)/Ts=36.22%*U*I.

Therefore, in this perhaps more realistic scenario the power losses of the four power devices are more similar to each other than in the above-captioned case of 10%. As the charging time in realistic situations is more likely to be of the order of 5% than of the order of 10%, this means that usually a greater balance between the power devices than for a charging time of 10% Ts may be obtained. Furthermore, by distributing the full current and associated power losses over the four power devices in particular during times when null vectors are applied, which make up a higher proportion of Ts than the times where active vectors (charging time) are applied, power losses in individual devices may be reduced compared to the reference examples of FIGS. 5 and 6, therefore reducing formation of hotspots. This in some embodiments may relax the requirements for designing the power devices, which in some cases may help to save costs.

FIG. 9 illustrates an example for the approach 1 mentioned above, and is given with a diagram similar to the diagrams of FIGS. 5, 6 and 8. Numeral 50 again denotes the control period, which in this case may have a duration Ts twice the duration Ts in FIG. 8, as in this case a lower control frequency Fs is sufficient as will be explained below. Each control period Ts may be divided into eight time slots I to VIII.

In particular, when the length of the control period is doubled in FIG. 9 compared to FIG. 8, the time T0 also doubles, such that the discharging periods in FIGS. 9 and 8 have the same length. Reducing the control frequency more depending on the implementation in each case may lead to torque shape and interrupted torque, as the current ripple may increase with shorter discharge periods.

In FIG. 9, curves 91 to 93 shows the control signals for phases U, V and W corresponding to voltages at the output nodes 112A to 112C, as was explained for the respective curves 51 to 53 of FIG. 5, 61 to 63 of FIGS. 6 and 81 to 83 of FIG. 8. A curve 94 shows the transient and average current of phase W and, where applicable, also for phase U. Numeral 95 denotes the average current through high-side switch 12C, numeral 96 denotes the average current through low-side switch 14A, numeral 97 denotes the average current through low-side switch 14B, numeral 98 denotes the average current through high-side switch 12B, numeral 99 denotes the average current through diode 13A, numeral 910 denotes the average current through diode 15C, numeral 911 denotes the average current through diode 15B and numeral 912 denotes the average current through diode 13B. Thick bars denote the full current flowing, and thinner bars denote half the full current flowing. At 913, current flow for the varying phases is shown.

Time slots I to VIII contain the four combinations of two vectors mentioned for approach 1 in sequence. In particular, in time slots I and II, \vec{V}₅->\vec{V}₀ is applied, in time slots III and IV \vec{V}₅->\vec{V}₇ is applied, in time slots V and VI \vec{V}₄->\vec{V}₇ is applied, and in phases VII and VIII \vec{V}₄->\vec{V}₀ is applied.

As can be seen by curve 94, compared to for example FIG. 8 in each control period Ts there are four charging times (during applying an active vector) and four discharging times (while applying the following null vector). Therefore, compared to FIG. 8, for application of the control scheme of FIG. 9 in some embodiments the control period Ts may have twice the length than the control period of FIG. 8, corresponding to half the control frequency Fs. For example, when the control frequency Fs=1/Ts is 2 kHz in FIG. 8, it may be 1 kHz in FIG. 9.

Furthermore, as can be seen from the thick bars in FIG. 9, again four of a total of eight power devices carrying current carry the full current, the same power devices as in FIG. 8, namely high-side switch 12C, low-side switch 14A, diode 13A and diode 15C.

Taking a charging time proportion 5% and the control period Ts with twice the length compared to FIG. 9, the conduction losses in the case of FIG. 9 are, calculated in the same manner as above:

P(high-side switch 12C)=P(low-side switch 14A)=38.4375%*U*I

P(diode 13A)=P(diode 15C)=36.5625%*U*I.

The following table summarizes the above calculated conduction power losses and compares them to the conventional case of FIG. 6:

TABLE 1

| | | FIG. 8 | FIG. 8 | FIG. 9 |
|---|---|---|---|---|
| | | conduction | conduction | conduction |
| | | power loss | power loss | power loss |
| | | (10% charg- | (5% charg- | (5% charg- |
| | | ing time) | ing time) | ing time) |
| | | (*U*I) | (*U*I) | (*U*I) |
| Conventional | Switches | 30% | 27.5% | * |
| PWM (FIG. 6) | 12C, 14A | | | |
| | Diodes | 45% | 47.5% | * |
| | 13A, 15C | | | |
| PWM of | Switches | 41.25% | 38.72% | 38.4375% |
| embodiments | 12C, 14A | | | |
| | Diodes | 33.75% | 36.22% | 36.5625% |
| | 13A, 15C | | | |
| Conduction | Hotspot | 8.3% | 18.5% | 19.1% |
| power loss | power | [(45- | [(47.5- | [(47.5- |
| improvement | devices | 41.25)/45] | 38.72)/47.5] | 38.43)/47.5] |
| by embodiment | | | | |

In the above table, for FIG. 6 a control frequency of 1 kHz as was applied to FIG. 9 is not possible, therefore here for the improvement calculation 2 kHz has been used as a control frequency in FIG. 6. As can be seen, conduction power loss in the hotspot devices is reduced in the embodiments by 8.3%, 18.5% and 19.1%, respectively, compared to the conventional case of FIG. 6. In case of FIG. 9, the minimum control frequency needed may be about half the minimum control frequency compared to the conventional case. It should also be noted that the improvement becomes greater when the charging time is reduced (greater improvement at 5% charging time compared to 10% charging time).

The conduction power losses dominate the complete power losses. Nevertheless, switching power losses also may have some impact.

In the examples of FIG. 8 (approach 2), switching power losses may be a bit higher than in the conventional case of FIG. 6, as more switching events occur. In particular, in this case in some implementations the switching frequency of power devices may be two to three times higher than in the conventional case. Nevertheless, as conduction power losses dominate compared to switching power losses, still power may be saved. For the case of FIG. 9 (approach 1), as the control frequency may be halved, the switching power losses are roughly the same or even slightly below the conventional case. In this respect, it should be noted that the transitions between adjacent vectors in the example of FIG. 9 is as smooth as in the conventional sequence of FIG. 6.

It should be noted that FIGS. 5, 6, 8 and 9 show examples for sector 4, i.e., an even sector. For odd sectors, the positions of \vec{V}ₖ and \vec{V}ₖ₊₁ may be reversed. When nor particular order is implied, the two active vectors delimiting a sector may also be referred to as \vec{V}ₐ and \vec{V}_{b}.

In summary by the various approaches and techniques disclosed herein, power losses when driving a three-phase power inverter to control an electric motor may be reduced.

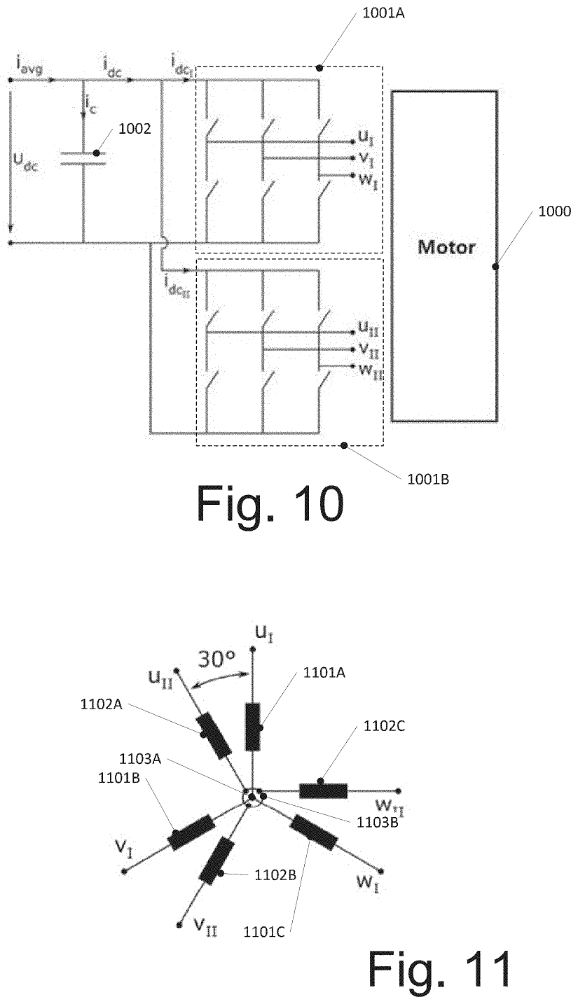

In the embodiments described above, a three-phase inverter is used to control a three-phase motor. This, however, is not to be construed as limiting. For example, the FOC control as discussed above may also be applied to a dual three-phase motor controlled by two three-phase inverters. This will be briefly explained referring to FIGS. 10 and 11.

FIG. 10 shows a system comprising a dual three-phase motor 1000 controlled by a first three-phase inverter 1001A and a second three-phase inverter 1001B. Each of three-phase inverters 1001A, 1001B may be controlled according to techniques discussed above, i.e., such that at least in a mode of operation like a locked rotor conditions for each three-phase inverter 1001A, 1001B four power devices take turn in bearing a full current during application of null vectors. Three-phase inverters 1001A, 1001B are supplied by a supply voltage U_{dc} via a filtering capacitor 1002 in the example system of FIG. 10.

A dual three-phase motor is a motor, which includes two sets of three windings. In some implementations, the two sets are electrically isolated from each other. In other implementations, the two sets may have a common electrical node. An example for the first case is shown in FIG. 11.

FIG. 11 schematically shows a motor including a first set of windings 1101A, 1101B and 1101C and a second set of windings 1102A, 1102A and 1102C. The first set of windings is offset to the second set of windings by an angle, which is 30° in the example of FIG. 11. Windings 1101A, 1101B and 1101C may be supplied by phases u₁, v₁ and w₁ from first three-phase inverter 1001A of FIG. 10, respectively, and windings 1102A, 1102B and 1102C may be supplied by phases u₁₁, v₁₁ and w₁₁ from first three-phase inverter 1001A of FIG. 10. In FIG. 11, windings 1101A, 1101B and 1101C are electrically coupled with each other at a node 1103A, and windings 1102A, 1102B, 1102C are electrically coupled with each other at a node 1103B. However, the first and second set of windings are not electrically connected.

In other embodiments, 6-phase motors may be driven in a similar manner to the dual three-phase motor explained with reference to FIGS. 10 and 11, with a similar inverter arrangement as shown in FIG. 10, which the acts as a six-phase inverter. Here, a single 6 phase control scheme is used, which may be a combination of two control schemes as discussed above for two groups of three windings. In such a six-phase motor, the windings of the motor are electrically connected at a common node.

Some embodiments are defined by the following examples:

### Example 1

A pulse width modulation pattern generator configured to control a three-phase power inverter;

wherein the three-phase power inverter comprises three half-bridges each comprising two switches and two diodes coupled in anti-parallel to the switches as power devices;

wherein the pulse width modulation pattern generator is configured to control the three-phase power inverter using field-oriented control via space vector pulse width modulation;

wherein, in at least one mode of operation, the pulse width modulation pattern generator is adapted to control the three-phase power inverter such that in each control period of the space vector pulse width modulation, at least four of the power devices of the three-phase power inverter take turns in bearing a full current during application of a null vector;

null vectors being vectors where all three half-bridges are controlled in a same manner; and

wherein a full current is an absolute current value of a maximum phase current among three phase currents of the three-phase power inverter.

### Example 2

The pulse width modulation pattern generator of example 1;

wherein the pulse width modulation pattern generator is configured to control the three-phase power inverter using field-oriented control via space vector pulse width modulation based on a feedback angle and control vectors selected based on the feedback angle.

### Example 3

The pulse width modulation pattern generator of example 1 or 2;

wherein the at least one mode of operation is;

a mode of operation with a locked rotor condition of a motor controlled by the three-phase power inverter; or

a mode of operation where a rotation speed of the motor is below a predefined threshold.

### Example 4

The pulse width modulation pattern generator of any one of examples 1 to 3; and

wherein in the at least one mode of operation, in each control period the control is based on two active vectors delimiting a sector indicated by a feedback angle and on two different null vectors.

### Example 5

The pulse width modulation pattern generator of example 4;

wherein the pulse width modulation pattern generator is adapted to employ, in the at least one mode of operation, in each control period; and

four different sequences of the two active vectors and the two null vectors, each sequence including one of the two active vectors and one of the two null vectors.

### Example 6

The pulse width modulation pattern generator of example 5;

wherein the pulse width modulation pattern generator is adapted to control the three-phase power inverter in each control period according to a control scheme \vec{V}ₐ->\vec{V}₀->\vec{V}ₐ->\vec{V}₇->\vec{V}_{b}->\vec{V}₇->\vec{V}_{b}->\vec{V}₀; and

where \vec{V}ₐ, \vec{V}_{b} are the two active vectors, \vec{V}₇ is a first null vector, and \vec{V}₀ is a second null vector.

### Example 7

The pulse width modulation pattern generator of example 4;

wherein the pulse width modulation pattern generator is adapted to employ, in the at least one mode of operation, in each control period;

a first sequence including one of the active vectors followed by two different null vectors; and

a second sequence including the other one of the two active vectors followed by two different null vectors.

### Example 8

The pulse width modulation pattern generator of example 7;

wherein the first sequence is one of \vec{V}ₐ->\vec{V}₀->\vec{V}₇ or \vec{V}ₐ->\vec{V}₇->\vec{V}₀;

the second sequence is one of \vec{V}_{b}->\vec{V}₇->\vec{V}₀ or \vec{V}_{b}->\vec{V}₀->\vec{V}₇; and

where \vec{V}ₐ, \vec{V}_{b} are the two active vectors, \vec{V}₇ is a first null vector, and \vec{V}₀ is a second null vector.

### Example 9

The pulse width modulation pattern generator according to example 7 or 8;

wherein the pulse width modulation pattern generator is adapted to employ one of the active vectors between the first sequence and the second sequence.

### Example 10

The pulse width modulation pattern generator according to example 4;

wherein the pulse width modulation pattern generator is adapted to employ, in the at least one mode of operation, in each control period;

two different sequences of two vectors;|

each of the two different sequences including one of the two active vectors and a null vector; and

one sequence including one of the two active vectors followed by two different null vectors.

### Example 11

The pulse width modulation pattern generator according to example 10;

wherein each of the two different sequences includes the one of the two active vectors followed by the null vector.

### Example 12

A system, comprising:

the pulse width modulation pattern generator of any one of examples 1 to 11, and a three-phase power inverter coupled to the pulse width modulation pattern generator.

### Example 13

The system of example 12, further comprising a motor coupled to the three-phase power inverter.

### Example 14

The system of example 13, wherein the motor is a dual three phase motor, the system further comprising a further three-phase power inverter coupled to the motor and to the pulse width modulation pattern generator.

### Example 15

A system, comprising:

a six-phase power inverter, wherein the six-phase power inverter comprises six half-bridges each comprising two switches and two diodes coupled in anti-parallel to the switches as power devices;

a pulse width modulation pattern generator configured to control the six-phase power inverter;

wherein the pulse width modulation pattern generator is configured to control the six-phase power inverter using field-oriented control via space vector pulse width modulation;

wherein, in at least one mode of operation, the pulse width modulation pattern generator is adapted to control the six-phase power inverter such that in each control period of the space vector pulse width modulation, for each of two groups of three half-bridges of the six half-bridges at least four of the power devices of the three-phase power inverter take turns in bearing a full current during application of a null vector;

null vectors being vectors where all three half-bridges are controlled in a same manner; and

wherein a full current is an absolute current value of a maximum phase current among three phase currents of the three-phase power inverter.

### Example 16

A method for controlling a three-phase power inverter;

the three-phase power inverter comprising three half-bridges each comprising two switches and two diodes coupled in anti-parallel to the switches as power devices;

the method comprising:

using field-oriented control via space vector pulse width modulation; and

in at least one mode of operation, controlling the three-phase power inverter such that in each control period of the space vector pulse width modulation four of the power devices take turns in bearing a full current during application of a null vector;

null vectors being vectors where all three half-bridges are controlled in the same manner; and

wherein a full current is an absolute current value of a maximum phase current among three phase currents of the three-phase power inverter.

### Example 17

The method of example 16, wherein the using is based on a feedback angle and control vectors selected based on the feedback angle.

### Example 18

The method of example 16 or 17, wherein the at least one mode of operation is:

a mode of operation with a locked rotor condition of a motor controlled by the three-phase power inverter; or

a mode of operation where a rotation speed of the motor is below a predefined threshold.

### Example 19

The method of one of examples 16 to 18;

wherein in the at least one mode of operation in each control period the control is based on two active vector delimiting a sector indicated by a feedback angle and on two different null vectors.

### Example 20

The method of example 19;

wherein said controlling comprises employing, in the at least one mode of operation, in each control period;

four different sequences of the two active vectors and the two null vectors; and

each sequence including one of the two active vectors and one of the two null vectors.

### Example 21

The method of example 20;

wherein each sequence includes the one of the two active vectors followed by the one of the two null vectors.

### Example 22

The method of example 20 or 21;

wherein said controlling comprises controlling the three-phase power inverter in each control period according to a control scheme \vec{V}ₐ->\vec{V}₀->ₐ->\vec{V}₇->\vec{V}_{b}->\vec{V}₇->\vec{V}_{b}->\vec{V}₀, where \vec{V}ₐ, \vec{V}_{b} are the two active vectors, \vec{V}₇ is a first null vector, and \vec{V}₀ is a second null vector.

### Example 23

The method of example 19;

wherein said controlling comprises employing, in the at least one mode of operation, in each control period;

a first sequence including one of the active vectors followed by two different null vectors; and

a second sequence including the other one of the two active vectors followed by two different null vectors.

### Example 24

The method of example 23;

wherein the first sequence is one of \vec{V}ₐ->\vec{V}₀->\vec{V}₇ or \vec{V}ₐ->\vec{V}₇->\vec{V}₀; and

the second sequence is one of \vec{V}_{b}->\vec{V}₇->\vec{V}₀ or \vec{V}_{b}->\vec{V}₀->\vec{V}₇, where \vec{V}ₐ, \vec{V}_{b} are the two active vectors, \vec{V}₇ is a first null vector, and \vec{V}₀ is a second null vector.

### Example 25

The method according to example 23 or 24;

wherein said controlling comprises employing one of the active vectors between the first sequence and the second sequence.

### Example 26

The method according to example 19;

wherein said controlling comprises employing, in the at least one mode of operation, in each control period;

two different sequences of two vectors;

each sequence including one of the two active vectors and one of two null vectors; and

one sequence including one of the two active vectors followed by two different null vectors.

### Example 27

A computer program comprising a program code, which, when executed on one or more processors, causes execution of the method of any one of examples 16 to 26. Causing execution means in particular that the one or more processors act as controller controlling execution of the method.

### Example 28

A computer program comprising a program code for controlling a three-phase power inverter;

the three-phase power inverter comprising three half-bridges each comprising two switches and two diodes coupled in anti-parallel to the switches as power devices, which program code, when executed on one or more processors, causes using field-oriented control via space vector pulse width modulation; and

in at least one mode of operation, controlling the three-phase power inverter such that in each control period of the space vector pulse width modulation four of the power devices take turns in bearing a full current during application of a null vector;

null vectors being vectors where all three half-bridges are controlled in the same manner; and

wherein a full current is an absolute current value of a maximum phase current among three phase currents of the three-phase power inverter.

### Example 29

A tangible storage medium storing the computer program of example 27 or 28.

### Example 30

A device for controlling a three-phase power inverter;

the three-phase power inverter comprising three half-bridges each comprising two switches and two diodes anti-parallel to the switches as power devices;

the device comprising:

means for using field-oriented control via space vector pulse width modulation; and

means for controlling, in at least one mode of operation, the three-phase power inverter such that in each control period of the space vector pulse width modulation four of the power devices take turns in bearing a full current during application of a null vector;

null vectors being vectors where all three half-bridges are controlled in the same manner; and

wherein a full current is an absolute current value of a maximum phase current among three phase currents of the three-phase power inverter.

### Example 31

The device of example 30;

wherein the at least one mode of operation is a mode of operation with a locked rotor condition of a motor controlled by the three-phase power inverter; or

a mode of operation where a rotation speed of the motor is below a predefined threshold.

### Example 32

The device of example 30 or 31;

wherein in the at least one mode of operation, in each control period the control is based on two active vector delimiting a sector indicated by a feedback angle and on two different null vectors.

### Example 33

The device of example 32;

wherein said means for controlling comprises means for employing, in the at least one mode of operation, in each control period:

four different sequences of the two active vectors and the two null vectors; and

each sequence including one of the two active vectors and one of the two null vectors.

### Example 34

The device of example 33;

wherein said means for controlling comprises means for controlling the three-phase power inverter in each control period according to a control scheme \vec{V}ₐ->\vec{V}₀->\vec{V}ₐ->\vec{V}₇->\vec{V}_{b}->\vec{V}₇->\vec{V}_{b}->\vec{V}₀, where \vec{V}ₐ, \vec{V}_{b} are the two active vectors, \vec{V}₇ is a first null vector, and \vec{V}₀ is a second null vector.

### Example 35

The device of example 32;

wherein said means for controlling comprises means for employing, in the at least one mode of operation, in each control period:

a first sequence including one of the active vectors followed by two different null vectors; and

a second sequence including the other one of the two active vectors followed by two different null vectors.

### Example 36

The device of example 35;

wherein the first sequence is one of \vec{V}ₐ->\vec{V}₀->\vec{V}₇ or \vec{V}ₐ->\vec{V}₇->\vec{V}₀, and the second sequence is one of \vec{V}_{b}->\vec{V}₇->\vec{V}₀ or \vec{V}_{b}->\vec{V}₀->\vec{V}₇, where V, \vec{V}_{b} are the two active vectors, \vec{V}₇ is a first null vector, and \vec{V}₀ is a second null vector.

### Example 37

The device according to example 35 or 36;

wherein said means for controlling comprises means for employing one of the active vectors between the first sequence and the second sequence.

### Example 38

The method according to example 32;

wherein said means for controlling comprises means for employing, in the at least one mode of operation, in each control period:

two different sequences of two vectors;

each sequence including one of the two active vectors and one of two null vectors; and

one sequence including one of the two active vectors followed by two different null vectors.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
pulse width modulation pattern generator configured to be coupled to a three-phase power inverter, wherein the three-phase power inverter comprises three half-bridges, and each half-bridge of the three half-bridges comprises two switches and two diodes coupled in anti-parallel to the switches as power devices, wherein:
the pulse width modulation pattern generator is configured to control the three-phase power inverter using field-oriented control via space vector pulse width modulation,
in at least one mode of operation, in each control period of the space vector pulse width modulation, at least four of the power devices of the three-phase power inverter take turns in bearing a full current during application of a null vector,
the null vector is a vector in which all three half-bridges are controlled to be in a same state, and
the full current is an absolute current value of a maximum phase current among three phase currents of the three-phase power inverter.

2. The system of claim 1, wherein the at least one mode of operation is:
a mode of operation with a locked rotor condition of a motor controlled by the three-phase power inverter; or
a mode of operation where a rotation speed of the motor is below a predefined threshold.

3. The system of claim 1, wherein in the at least one mode of operation, in each control period the pulse width modulation pattern generator is configured to generate two active vectors delimiting a sector indicated by a feedback angle and on two different null vectors.

4. The system of claim 3, wherein the pulse width modulation pattern generator is adapted to employ, in the at least one mode of operation, in each control period:
four different sequences of the two active vectors and the two different null vectors, and
each sequence including one of the two active vectors and one of the two different null vectors.

5. The system of claim 4, wherein the pulse width modulation pattern generator is adapted to control the three-phase power inverter in each control period according to a control scheme \vec{V}ₐ->\vec{V}₀->\vec{V}ₐ->\vec{V}₇->\vec{V}_{b}->\vec{V}₇->\vec{V}_{b}->\vec{V}₀, where \vec{V}ₐ, \vec{V}_{b} are the two active vectors, \vec{V}₇ is a first null vector of the two different null vectors, and \vec{V}₀ is a second null vector of the two different null vectors.

6. The system of claim 3, wherein the pulse width modulation pattern generator is adapted to employ, in the at least one mode of operation, in each control period:
a first sequence including one of the active vectors followed by two different null vectors; and
a second sequence including the other one of the two active vectors followed by two different null vectors.

7. The system of claim 6, wherein the first sequence is one of \vec{V}ₐ->\vec{V}₀->\vec{V}₇ or \vec{V}ₐ->\vec{V}₇->\vec{V}₀, and the second sequence is one of \vec{V}_{b}->\vec{V}₇->\vec{V}₀ or \vec{V}_{b}->\vec{V}₀->\vec{V}₇, where \vec{V}ₐ, \vec{V}_{b} are the two active vectors, \vec{V}₇ is a first null vector of the two different null vectors, and \vec{V}₀ is a second null vector of the two different null vectors.

8. The system of claim 6, wherein the pulse width modulation pattern generator is adapted to employ one of the two active vectors between the first sequence and the second sequence.

9. The system of claim 3, wherein the pulse width modulation pattern generator is adapted to employ, in the at least one mode of operation, in each control period:
two different sequences of two vectors, each of the two different sequences including one of the two active vectors and the null vector; and
one sequence including one of the two active vectors followed by two different null vectors.

10. A method for controlling a three-phase power inverter comprising three half-bridges that each comprise two switches and two diodes coupled in anti-parallel to the switches as power devices, the method comprising:
controlling the three-phase power inverter using field-oriented control via space vector pulse width modulation;
wherein in at least one mode of operation, in each control period of the space vector pulse width modulation, four of the power devices take turns in bearing a full current during application of a null vector, the null vector is a vector in which all three half-bridges are controlled to be in a same state, and the full current is an absolute current value of a maximum phase current among three phase currents of the three-phase power inverter.

11. The method of claim 10;
wherein the at least one mode of operation is a mode of operation with a locked rotor condition of a motor controlled by the three-phase power inverter; or
a mode of operation where a rotation speed of the motor is below a predefined threshold.

12. The method of claim 10, wherein in the at least one mode of operation in each control period two active vectors are generated to delimit a sector indicated by a feedback angle and on two different null vectors.

13. The method of claim 12, wherein said controlling comprises employing, in the at least one mode of operation, in each control period:
four different sequences of the two active vectors and the two different null vectors; and
each sequence including one of the two active vectors and one of the two different null vectors.

14. The method of claim 13, wherein said controlling comprises controlling the three-phase power inverter in each control period according to a control scheme \vec{V}ₐ->\vec{V}₀->\vec{V}ₐ->\vec{V}₇->\vec{V}_{b}->\vec{V}₇->\vec{V}_{b}->\vec{V}₀, where \vec{V}ₐ, \vec{V}_{b} are the two active vectors, \vec{V}₇ is a first null vector, and \vec{V}₀ is a second null vector.

15. The method of claim 12, wherein said controlling comprises employing, in the at least one mode of operation, in each control period:
a first sequence including one of the active vectors followed by two different null vectors; and
a second sequence including the other one of the two active vectors followed by the two different null vectors.

16. The method of claim 15, wherein the first sequence is one of \vec{V}ₐ->\vec{V}₀->\vec{V}₇ or \vec{V}ₐ->\vec{V}₇->\vec{V}₀, and the second sequence is one of \vec{V}_{b}->\vec{V}₇->\vec{V}₀ or \vec{V}_{b}->\vec{V}₀->\vec{V}₇, Where \vec{V}ₐ, \vec{V}_{b} are the two active vectors, \vec{V}₇ is a first null vector of the two different null vectors, and \vec{V}₀ is a second null vector of the two different null vectors.

17. The method according to claim 15, wherein said controlling comprises employing one of the active vectors between the first sequence and the second sequence.

18. The method according to claim 12, wherein said controlling comprises employing, in the at least one mode of operation, in each control period:
two different sequences of two vectors, wherein each sequence includes one of the two active vectors and one of two null vectors; and
one sequence including one of the two active vectors followed by two different null vectors.

19. A non-transitory machine readable medium having stored thereon a program having a program code for performing the method of claim 10, when the program is executed on a processor.

20. A system, comprising:
a three-phase power inverter comprising three half-bridges, wherein each half-bridge of the three half-bridges comprises two switches and two diodes coupled in anti-parallel to the switches as power devices; and
a pulse width modulation generator having outputs coupled to control nodes of each half-bridge of the three half-bridges of the three-phase power inverter, the pulse width modulation generator configured to control the three-phase power inverter using field-oriented control via space vector pulse width modulation, wherein
in at least one mode of operation, in each control period of the space vector pulse width modulation, at least four of the power devices of the three-phase power inverter take turns in bearing a full current during application of a null vector, wherein the null vector is a vector in which all three half-bridges are controlled to be in a same state, and
the full current is an absolute current value of a maximum phase current among three phase currents of the three-phase power inverter.
